(19) United States
(12) Patent Application Publication
(10) Pub. No.: US 2013/0072046 A1
(43) Pub. Date: Mar. 21, 2013

(54) DUAL LATCH ELECTRICAL PLUG CONNECTOR FOR ELECTRICAL RECEPTACLE

(71) Applicants: Edward BAZAYEV, Kew Gardens, NY (US); Thomas Louis SCANZILLO, Monroe, CT (US)

(72) Inventors: Edward BAZAYEV, Kew Gardens, NY (US); Thomas Louis SCANZILLO, Monroe, CT (US)

(73) Assignee: HUBBELL INCORPORATED, Shelton, CT (US)

(21) Appl. No.: 13/234,791

(22) Filed: Sep. 16, 2011

(51) Int. Cl. H01R 13/62; H01R 13/627

(52) U.S. Cl. 439/357; 439/350

(57) ABSTRACT

An electrical plug connector includes a housing and first and second latching arms pivotally connected to the housing. First and second barriers are connected to the housing to protect the first latching arm. Third and fourth barriers are connected to the housing to protect the second latching arm. The barriers protect the first and second latching arms from being accidentally disengaged from an electrical wiring device by wires or other objects.

### FIELD OF THE INVENTION

The present invention relates to an electrical connector having dual latches for connecting to an electrical device. More particularly, the present invention relates to an electrical connector having dual latches oppositely disposed to provide an ergonomic connector having a more secure connection with an electrical device. Still more particularly, the present invention relates to a dual-latch electrical connector having barriers to protect the latches from accidental disengagement from an electrical device.

### BACKGROUND OF THE INVENTION

To facilitate connecting electrical wires to an electrical device, such as an electrical receptacle, some electrical devices have apertures in their rear faces for receiving plug connectors terminating a plurality of wires, as disclosed in U.S. Pat. No. 4,842,551 to Heimann. The wires terminated by the plug connector are connected to the existing wires in any suitable manner, such as by a clamp receptacle or a wire nut. Thus, an electrician is not required to connect the plug connector to the receptacle.

Existing plug connectors have a single latch to secure the plug connector to an aperture in the rear face of an electrical device. During installation, the installer must use three fingers to grip the electrical connector—one finger on each of the opposite sides of the plug connector and a third finger on the latch. Gripping such a plug connector with three fingers can be difficult and cumbersome when working in confined areas. Accordingly, a need exists for a plug connector that is more easily manipulated, particularly in confined areas.

Such existing plug connectors having a single latch to secure the plug connector to the aperture in an electrical receptacle are subject to accidental disengagement when installing the electrical receptacle in an electrical box. Manipulation of the electrical receptacle during installation can put undue stress on the latch, thereby causing the plug connector to become disengaged from the electrical receptacle. Accordingly, a need exists for a plug connector having a more secure connection to the electrical device.

Another drawback to existing plug connectors that are secured to apertures in rear faces of electrical devices is that those plug connectors are prone to being accidentally disengaged from the aperture. The latch used to secure the plug connector to the aperture is exposed and subject to contact by a wire or other object that can cause the latch to disengage the aperture of the electrical device. Accordingly, a need exists for an improved plug connector that protects the plug connector from being accidentally disengaged from the electrical device.

### SUMMARY OF THE INVENTION

Accordingly, it is a primary objective of the present invention to provide an ergonomic plug connector that facilitates connecting to an electrical device.

A further objective of the present invention is to provide a dual-latch plug connector that securely connects to an electrical wiring device.

Another objective of the present invention is to provide a dual-latch plug connector having shields to protect accidentally disengaging the plug connector from an electrical device to which it is connected.

The foregoing objectives are basically attained by an electrical plug connector including a housing and first and second latching arms pivotally connected to the housing. First and second barriers are connected to the housing to protect the first latching arm. Third and fourth barriers are connected to the housing to protect the second latching arm. The barriers protect the first and second latching arms from being accidentally disengaged from an electrical wiring device by wires or other objects.

The foregoing objectives are also basically attained by an electrical wiring device assembly including an electrical wiring device and an electrical plug connector connected thereto. The electrical plug connector is received by an aperture in a rear surface of the electrical wiring device. The electrical plug connector includes a housing and first and second latching arms pivotally connected thereto and engaging the electrical wiring device to secure the electrical plug connector thereto. First and second barriers are connected to the housing to protect the first latching arm. Third and fourth barriers are connected to the housing to protect the second latching arm. A plurality of wires are connected to the electrical plug connector. The barriers protect the first and second latching arms from being accidentally disengaged from an electrical wiring device by wires or other objects.

Other objects, advantages and salient features of the invention will become apparent from the following detailed description, which, taken in conjunction with the annexed drawings, discloses a preferred embodiment of the invention.

As used in this application, the terms “front,” “rear,” “upper,” “lower,” “upwardly,” “downwardly,” and other orientational descriptors are intended to facilitate the description of the electrical plug connector and the electrical wiring device, and are not intended to limit the structure of the electrical plug connector and the electrical wiring device to any particular position or orientation.

### BRIEF DESCRIPTION OF THE DRAWINGS

The above benefits and other advantages of the various embodiments of the present invention will be more apparent from the following detailed description of an exemplary embodiment of the present invention and from the accompanying drawing figures, in which:

FIG. 1 is a rear perspective view of a dual-latch electrical connector according to an exemplary embodiment of the present invention connected to an aperture in a rear face of an electrical receptacle;

FIG. 2 is a side perspective view of the dual-latch electrical connector of FIG. 1;

FIG. 3 is a rear perspective view of the electrical receptacle of FIG. 1;

FIG. 4 a rear perspective view of the dual-latch electrical connector prior to being connected to the electrical receptacle of FIG. 1;

FIG. 5 is a front perspective view of the dual-latch electrical connector of FIG. 1;

FIG. 6 is a rear perspective view of the dual-latch electrical connector of FIG. 1;

FIG. 7 is a rear elevational view of the dual-latch electrical connector of FIG. 4;

FIG. 8 is a side elevational view of the dual-latch electrical connector of FIG. 4;

FIG. 9 is a side elevational view in cross section of the dual-latch electrical connector of FIG. 4;

FIG. 10 is a front elevational view of the of the dual-latch electrical connector of FIG. 4;

FIG. 11 is a top plan view of the dual-latch electrical connector of FIG. 4;

FIG. 12 is a top plan view in cross section taken along line 12-12 of the dual-latch electrical connector of FIG. 10;

FIG. 13 is a side elevational view of the dual-latch electrical connector connected to the electrical receptacle of FIG. 1;

FIG. 14 is a top plan view in cross section of the dual-latch electrical connector connected to the electrical receptacle taken along line 14-14 of FIG. 13;

FIG. 15 is an enlarged view of the dual-latch electrical connector engaging an overhang of the electrical receptacle of FIG. 14.

Throughout the drawings, like reference numbers will be understood to refer to like parts, components and structures.

### DETAILED DESCRIPTION OF THE EXEMPLARY EMBODIMENT

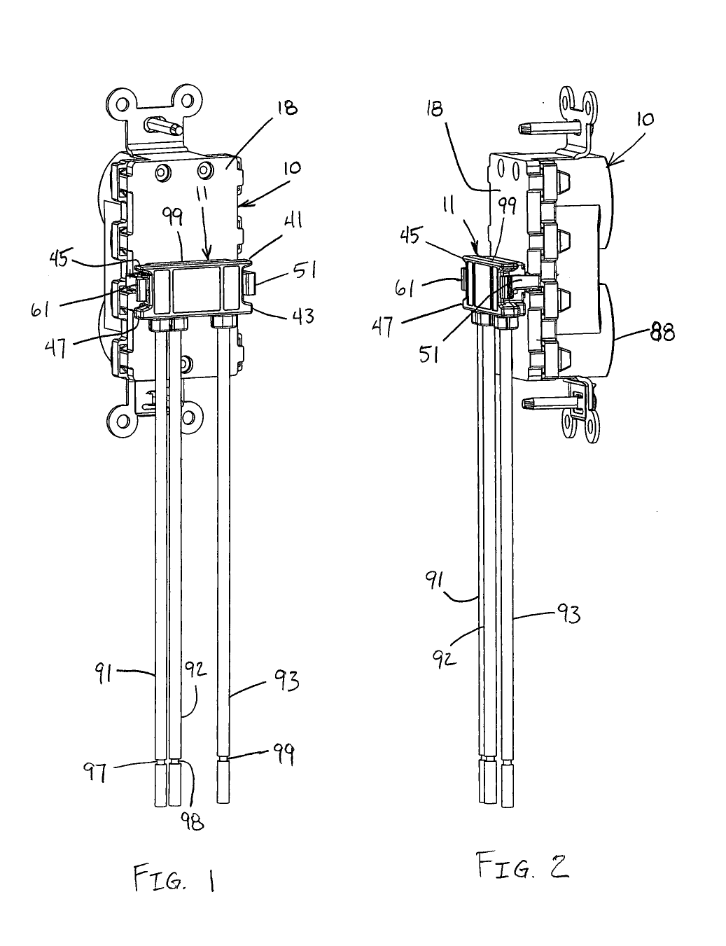

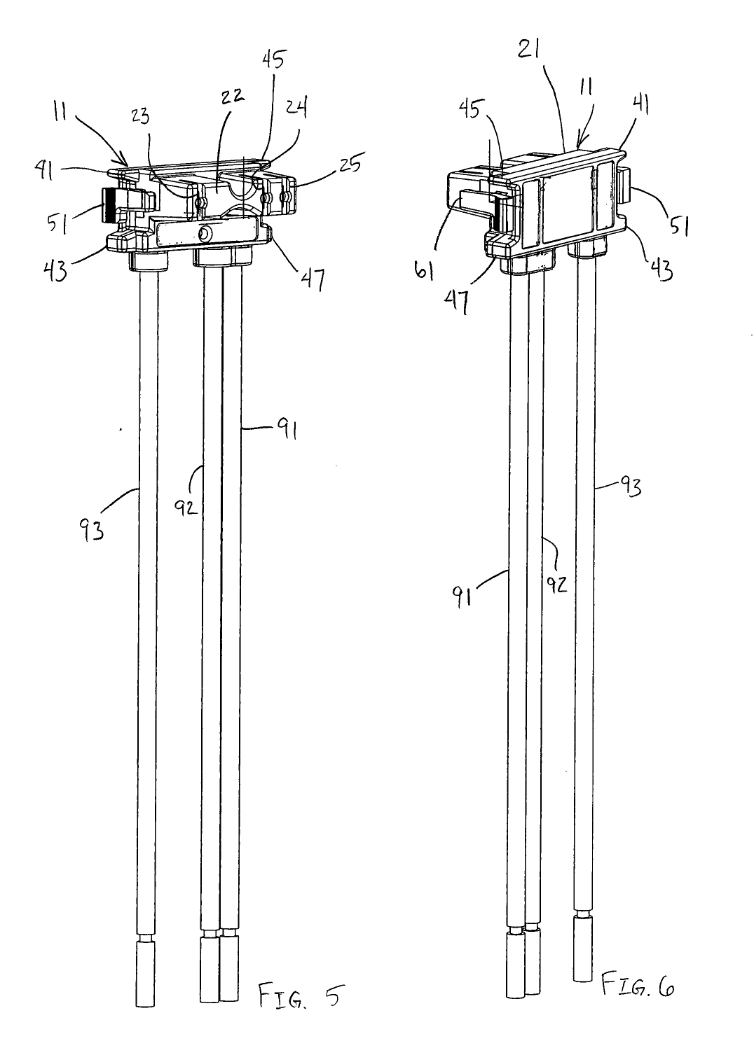

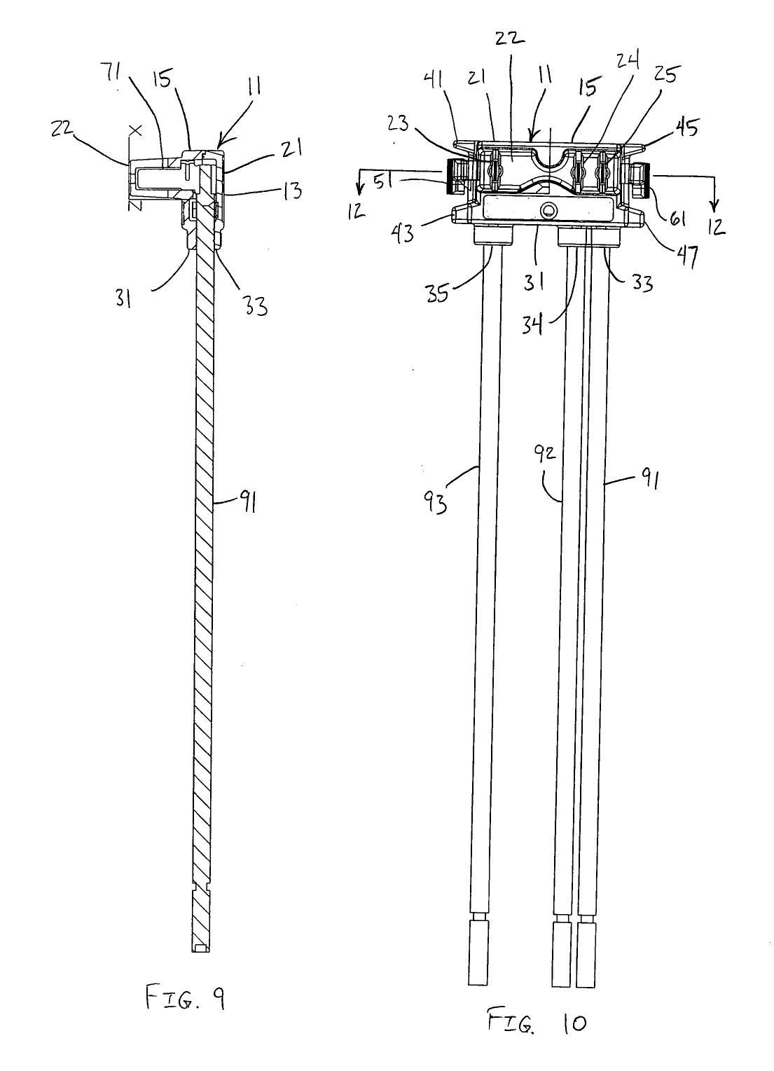

As shown in FIGS. 1-15, an electrical plug connector 11 includes a housing 21 and first and second latching arms 51 and 61, respectively. The plug connector 11 is receivable by an electrical wiring device, such as the electrical receptacle 10 shown in FIGS. 1-4 and 13. The plug connector 11 is connected to a snap-on type electrical receptacle 10, or any other snap-on type electrical wiring device, to convey electrical power to the electrical wiring device. Accordingly, an electrical apparatus (not shown) can be connected to the electrical receptacle 10 to receive power therefrom.

The plug connector 11 described has three wires 91, 92 and 93 connected thereto, as shown in FIGS. 1, 2 and 4-10, although the plug connector of the present invention is not so limited. Any suitable number of wires may be used as required by the electrical device with which the plug connector is used. These three wires 91, 92 and 93 are connectable to the building wiring extending into a standard electrical box mounting the electrical receptacle 10.

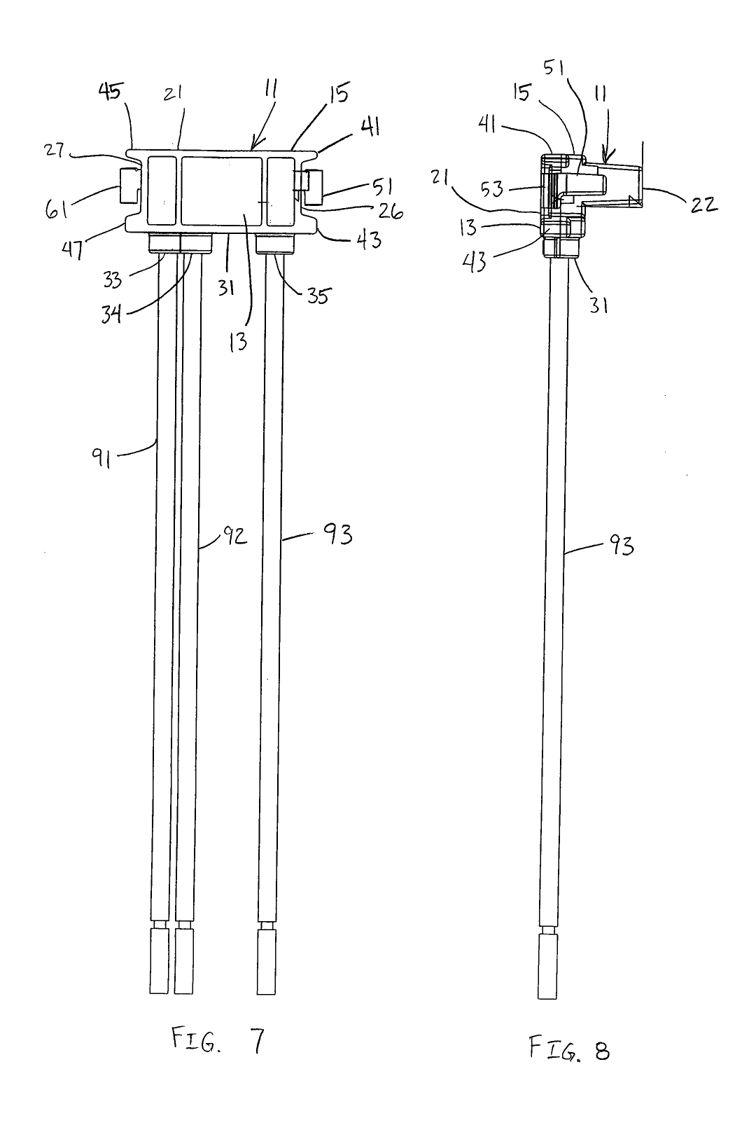

The plug connector housing 21 is preferably unitarily formed as a one-piece member, as shown in FIGS. 7, 11 and 12. A plurality of slots 23, 24 and 25 are disposed in a front surface 22 of the plug connector housing 21, as shown in FIG. 5. A plurality of openings 33, 34 and 35 are formed in a bottom surface 31 of the plug connector housing 21, as shown in FIGS. 7 and 8. A passageway is formed between each pair of corresponding slots and openings, i.e., a first passageway 36 between slot 23 and opening 33, a second passageway 37 between slot 24 and opening 34, and a third passageway 38 between slot 25 and opening 35. First, second and third contact members 71, 72 and 73 are disposed in the first, second and third passageways 36, 37 and 38, respectively. Alternatively, first and second housings can be connected together, such as by a snap fit, to form the housing 21.

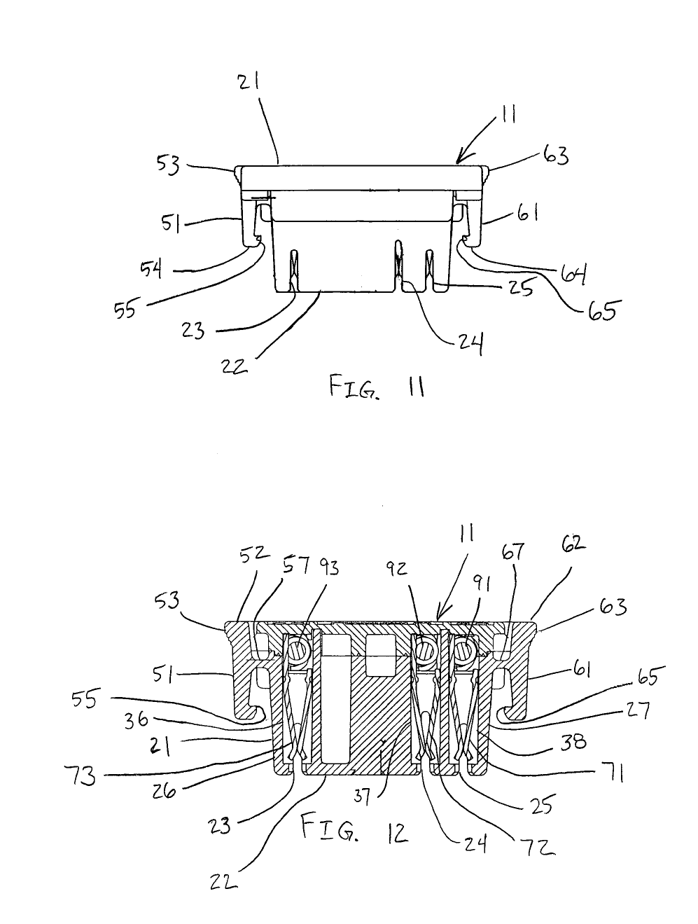

The plug connector housing 21 has a rear surface 13 disposed opposite the front surface 22. An upper surface 15 is disposed opposite the bottom surface 31 in which the wire openings 33, 34 and 35 are formed. First and second side surfaces 26 and 27 extend between the upper and bottom surfaces, as shown in FIG. 12.

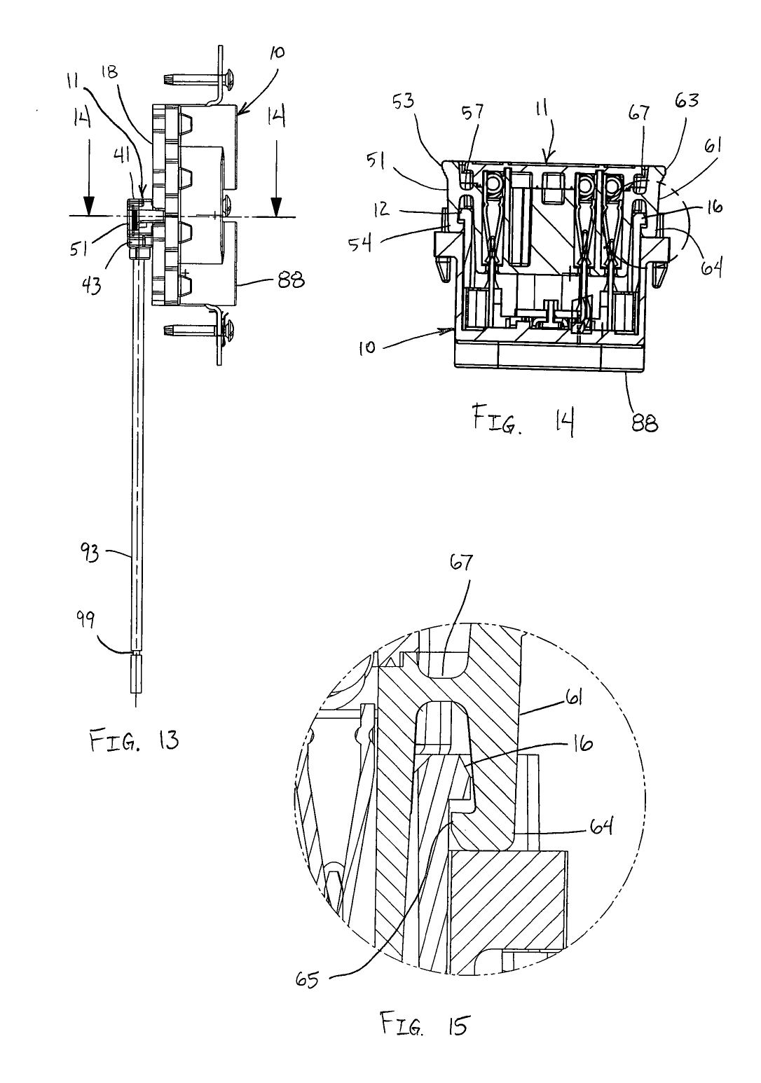

A first latching arm 51 extends substantially parallel to the first side surface 26 of the plug connector housing 21, as shown in FIGS. 11 and 12. The first latching arm 51 is pivotable to facilitate connecting to and disengaging from the electrical receptacle 10. The first latching arm 51 is deflectable to facilitate disengaging the plug connector 11 from a mated connection with the electrical receptacle 10. A first latching arm deflecting member 53 is disposed at a rearward end 52 of the first latching arm 51. A first latch 55 extends inwardly from a forward end 54 of the first latching arm 51 and engages a first overhang 12 (FIG. 3) of the electrical receptacle 10 to secure the plug connector 11 to the electrical receptacle. A first flexible connecting arm 57 pivotally connects the first latching arm 51 to the first side surface 26 of the plug connector housing 21, as shown in FIG. 12. The first connecting arm 57 is disposed between the forward and rearward ends 52 and 54 of the first latching arm 51. The first connecting arm 57 preferably extends substantially perpendicularly to the first side surface 26. The first connecting arm 57 allows the first latching arm 51 to rotate pivot about the connecting arm to allow engagement and disengagement of the first latching arm with the first overhang 12 of the electrical receptacle 10, as shown in FIGS. 14 and 15.

A second latching arm 61 extends substantially parallel to the second side surface 27 of the plug connector housing 21, as shown in FIGS. 11 and 12. The second latching arm 61 is pivotable to facilitate connecting to and disengaging from the electrical receptacle 10. The second latching arm 61 is deflectable to facilitate disengaging the plug connector 11 from a mated connection with the electrical receptacle 10. A second latching arm deflecting member 63 is disposed at a rearward end 62 of the second latching arm 61. A second latch 65 extends inwardly from a forward end 64 of the latching arm 61 and engages a second overhang 16 (FIG. 3) of the electrical receptacle 10 to secure the plug connector 11 to the electrical receptacle. A second flexible connecting arm 67 pivotally connects the second latching arm 61 to the second side surface 27 of the plug connector housing 21, as shown in FIG. 12. The second connecting arm 67 is disposed between the forward and rearward ends 62 and 64 of the second latching arm 61. The second connecting arm 67 preferably extends substantially perpendicularly to the second side surface 27. The second connecting arm 67 allows the second latching arm 61 to rotate pivot about the connecting arm to allow engagement and disengagement of the second latching arm with the second overhang 16 of the electrical receptacle 10, as shown in FIGS. 14 and 15.

First and second barriers 41 and 43 extend outwardly from the first side surface 26 of the plug connector housing 21, as shown in FIGS. 7 and 8. Third and fourth barriers 45 and 47 extend outwardly from the second side surface 27 and are opposite the first and second barriers 41 and 43, respectively. The first and second barriers 41 and 43 extend along the first side surface 26 to cover at least a majority of the first deflecting member 53 to substantially prevent wires and other objects from accidentally causing the first latching arm 51 to disengage from the aperture 17 of the electrical receptacle 10. The third and fourth barriers 45 and 47 extend along the second side surface 27 to cover at least a majority of the second deflecting member 63 to substantially prevent wires and other objects from accidentally causing the second latching arm 61 to disengage from the aperture 17 of the electrical receptacle 10.

The first and second latches 55 and 65 engage the first and second overhangs 12 and 16 of the electrical receptacle 10, as shown in FIGS. 1-4, 14 and 15 to prevent the plug connector 11 from being withdrawn from the electrical receptacle. The first and second overhangs 12 and 16 are disposed on opposite sides of an aperture 17 in a rear surface 18 of the electrical receptacle 10, as shown in FIGS. 14 and 15. The first and second deflecting members 53 and 63 are deflected inwardly against the biasing of the integral hinges provided by the flexible connecting arms 57 and 67 such that the first and second latches 55 and 65 rotate outwardly, thereby disengaging the first and second overhangs 12 and 16 to allow the plug connector 11 to be withdrawn from the aperture 17. Pushing the first and second deflecting members 53 and 63 inwardly toward the first and second side surfaces 26 and 27 allows the plug connector 11 to be disconnected from the electrical receptacle 10.

### Assembly and Operation

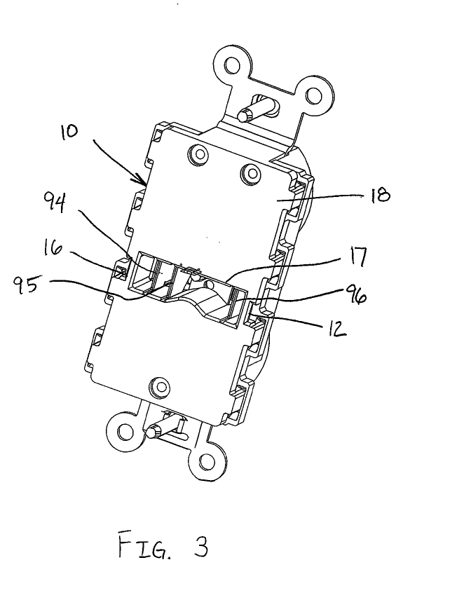

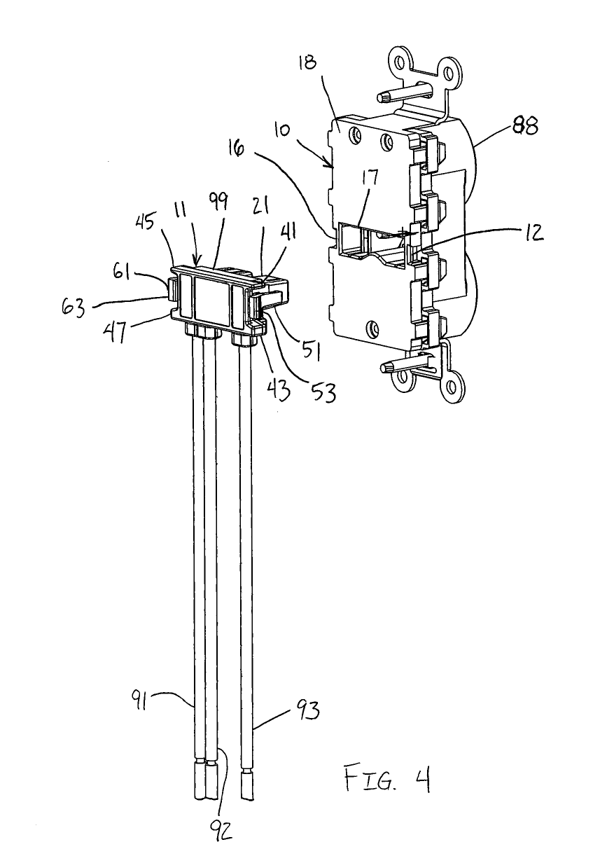

The plug connector 11 is shown connected to an electrical receptacle 10 in FIGS. 1 and 2, and disengaged therefrom in FIG. 4. The electrical receptacle 10 has three contact members, or blades, 94, 95 and 96 disposed in the aperture 17, as shown in FIG. 3 and electrically connected to the receptacle contacts. Each receptacle contact member 94, 95 and 96 passes through the corresponding slot 23, 24 and 25 in the front face 22 of the plug connector housing 21 to engage with the plug contact members 73, 72 and 71, respectively. Electrical power is supplied through the building wires, through the plug connector wires 91, 92 and 93, through the plug contact members 71, 72 and 73, through the receptacle contact members 94, 95 and 96 and to the device connected to electrical receptacle.

Wires 91, 92 and 93 are passed through openings 33, 34 and 35 in the plug connector housing 21, as shown in FIGS. 1, 2, 4, 5-10 and 12. Insulation is removed from the end of the wires as required to facilitate passing the wires through the openings 33, 34 and 35 in the plug connector housing 21 and terminating the wires with electrical contacts 71, 72 and 73.

Grooves 97, 98 and 99 can be cut in the insulation on the plug connector wires 91, 92 and 93, as shown in FIG. 1, to facilitate removing insulation from the free ends of the plug connector wires. The plug connector wires are then connected to the building wires in any conventional manner, such as with wire nuts.

The electrical plug connector 11 is then ready to be connected to the electrical receptacle 10, as shown in FIGS. 1-4. The electrical receptacle 10 has a rear face 18 having an aperture 17 therein adapted to receive the plug connector 11. Electrical contact members 94, 95 and 96 are disposed within the aperture 17. Each electrical contact members 71, 72 and 73 of the plug connector 11 has a corresponding blade within the aperture 17. Accordingly, for the plug connector 11 having three electrical contacts 71, 72 and 73, there are three electrical contact members 94, 95 and 96 in the aperture 17 of the electrical receptacle 10. The plug connector 11 is inserted in the aperture 17, such that each electrical contact member 71, 72 and 73 of the plug connector 11 engages a contact member 94, 95 and 96 of the electrical receptacle 10, until a wall 99 engages the rear surface 18 of the electrical receptacle 10, as shown in FIGS. 1, 2 and 4. The receptacle overhangs 12 and 16 engage the latches 55 and 65 of the latching arms 51 and 61 and are held engaged by the biasing of arms 57 and 67, as shown in FIGS. 14 and 15. The flexible connecting arms 57 and 67 allow the latches 55 and 65 to flex outwardly to pass over the overhangs 12 and 16. Once the latches 55 and 65 pass behind the overhangs 12 and 16, the plug connector 11 is securely retained within the aperture 17 of the electrical receptacle 10. The latches 55 and 65 substantially prevent withdrawal of the plug connector 11 from the aperture 17 by abutting the overhangs 12 and 16. Depressing the deflecting members 53 and 63, deflects the latches 55 and 65 outwardly (away from the side surfaces 26 and 27), such that the overhangs 12 and 16 do not prevent the plug connector 11 from being withdrawn. The barriers 41, 43, 45 and 47 protect the latching arms 51 and 61 from being pivoted by wires or other objects to accidentally withdraw the plug connector 11 from the electrical receptacle 10. As shown in FIGS. 1 and 2, the wires 91, 92 and 93 extend substantially parallel to a rear surface 18 of the electrical receptacle 10. Alternatively, the plug connector wires 91, 92 and 93 can extend in any direction with respect to the rear surface 18 of the electrical receptacle 10, such as substantially perpendicular thereto.

When the plug connector 11 is connected to the electrical contact members 94, 95 and 96 of the electrical receptacle 10, electrical power is transmitted through the plug connector 11 to an electrical apparatus connected to a front face 88 of the electrical receptacle 10. An ergonomic plug connector 11 is provided by oppositely disposing latching arms 51 and 61, as shown in FIG. 4. An installer can easily grasp and manipulate the plug connector 11 with two fingers, thereby allowing for easier installation of the plug connector in confined areas.

While an advantageous embodiment has been chosen to illustrate the invention, it will be understood by those skilled in the art that various changes and modifications may be made therein without departing from the scope of the invention as defined in the appended claims.

The foregoing embodiments and advantages are merely exemplary and are not to be construed as limiting the scope of the present invention. The description of an exemplary embodiment of the present invention is intended to be illustrative, and not to limit the scope of the present invention. Various modifications, alternatives and variations will be apparent to those of ordinary skill in the art, and are intended to fall within the scope of the invention as defined in the appended claims.

What is claimed is:

1. An electrical plug connector, comprising:
a housing;
first and second latching arms pivotally connected to said housing;
first and second barriers connected to said housing to protect said first latching arm; and
third and fourth barriers connected to said housing to protect said second latching arm.

2. The electrical plug connector according to claim 1, wherein
said first and second latching arms are oppositely disposed on opposite sides of said housing.

3. The electrical plug connector according to claim 1, wherein
latches are disposed at ends of said first and second latching arms to engage an electrical receptacle.

4. The electrical plug connector according to claim 3, wherein
first and second deflecting members are disposed at ends of said first and second latching arms, respectively, to pivot said first and second latching arms.

5. The electrical plug connector according to claim 1, wherein
first and second connecting arms connect said first and second latching arms, respectively, to said housing.

6. The electrical plug connector according to claim 1, wherein
said first and second latching arms extend substantially parallel to first and second side surfaces of said housing.

7. The electrical plug connector according to claim 5, wherein
said first and second connecting members are connected to said first and second latching arms between opposite ends thereof.

8. The electrical plug connector according to claim 1, wherein
a plurality of slots in said housing are adapted to engage contact members of an electrical receptacle; and
a plurality of openings in said housing are adapted to receive electrical wires.

9. The electrical plug connector according to claim 8, wherein
said plurality of slots are disposed in said housing such that said received wires are substantially parallel or substantially perpendicular to a rear surface of the electrical receptacle.

10. The electrical plug connector according to claim 4, wherein
said first and second barriers cover at least a portion of said first deflecting member; and
said third and fourth barriers cover at least a portion of said second deflecting member.

11. The electrical plug connector according to claim 5, wherein
said first and second connecting arms extend substantially perpendicularly to said housing, respectively.

12. An electrical wiring device assembly, comprising:
an electrical wiring device having an aperture in a rear surface thereof; and
an electrical plug connector received by said aperture, said electrical plug connector including
a housing;
first and second latching arms pivotally connected to said housing and engaging said electrical receptacle to secure said electrical plug connector thereto;
first and second barriers connected to said housing to protect said first latching arm;
third and fourth barriers connected to said housing to protect said second latching arm; and
a plurality of wires connected to said electrical plug connector.

13. The electrical wiring device assembly according to claim 12, wherein
said first and second latching arms are oppositely disposed on opposite sides of said housing.

14. The electrical wiring device assembly according to claim 12, wherein
latches are disposed at ends of said first and second latching arms to engage overhangs of said electrical receptacle.

15. The electrical wiring device assembly according to claim 14, wherein
first and second deflecting members are disposed at ends of said first and second latching arms, respectively, to pivot said first and second latching arms.

16. The electrical wiring device assembly according to claim 12, wherein
first and second connecting arms connect said first and second latching arms, respectively, to said housing.

17. The electrical wiring device assembly according to claim 12, wherein
said first and second latching arms extend substantially parallel to first and second side surfaces of said housing.

18. The electrical wiring device assembly according to claim 16, wherein
said first and second connecting arms connected to said first and second latching arms between opposite ends thereof.

19. The electrical wiring device assembly according to claim 15, wherein
said first and second barriers cover at least a portion of said first deflecting member; and
said third and fourth barriers cover at least a portion of said second deflecting member.

20. The electrical wiring device assembly according to claim 12, wherein
said plurality of wires extend substantially parallel or substantially perpendicular to said rear surface of said electrical wiring device.
